(19) United States
(12) Patent Application Publication
(10) Pub. No.: US 2010/0055409 A1
(43) Pub. Date: Mar. 4, 2010

(54) OPTICAL COMPOSITE AND METHOD OF MANUFACTURING THE SAME

(75) Inventors: Yoon Hee Cho, Yongin-si (KR); Hee Cheong Lee, Yongin-si (KR); Hyung Soo Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Gwacheon-si (KR)

(21) Appl. No.: 12/521,791

(22) PCT Filed: Jan. 2, 2008
(86) PCT No.: PCT/KR08/00007

§ 371 Date: Aug. 4, 2009

(30) Foreign Application Priority Data
Jan. 2, 2007 (KR) 10-2007-0000068
Dec. 14, 2007 (KR) 10-2007-0131520
Dec. 14, 2007 (KR) 10-2007-0131522
Jan. 2, 2008 (KR) 10-2008-0000053
Jan. 2, 2008 (KR) 10-2008-0000057

(51) Int. Cl. B32B 3/00; G02B 5/02; B29C 47/02

(52) U.S. Cl. 428/172; 156/244.17

(57) ABSTRACT

Disclosed is an optical composite for use in a backlight unit of a liquid crystal display or an illumination apparatus, which is able to sufficiently increase luminance and in which adhesion portions are regularly arranged to thus induce an optical illusion effect so that scratches or stains cannot be seen clearly. A method of manufacturing such an optical composite is also provided. There is no need to additionally use optical films or prism sheets, thus making it possible to inexpensively manufacture optical devices, such as backlight units.

### TECHNICAL FIELD

The present invention relates to an optical composite for use in a liquid crystal display, and to a method of manufacturing the same.

### BACKGROUND ART

As industrial society has developed toward an advanced information age, the importance of electronic displays as a medium for displaying and transferring various pieces of information is increasing day by day. Conventionally, a CRT (Cathode Ray Tube), which is bulky, was widely used therefor, but faces considerable limitations in terms of the space required to mount it, thus making it difficult to manufacture CRTs having larger sizes. Accordingly, CRTs are being replaced with various types of flat panel displays, including liquid crystal displays (LCDs), plasma display panels (PDPs), field emission displays (FEDs), and organic electroluminescent displays. Among such flat panel displays, in particular, LCDs, a technologically intensive product resulting from a combination of liquid crystal-semiconductor techniques, are advantageous because they are thin and light and consume little power. Therefore, research and development into structures and manufacturing techniques thereof has continued. Nowadays, LCDs, which have already been applied in fields such as notebook computers, monitors for desktop computers, and portable personal communication devices (PDAs and mobile phones), are manufactured in larger sizes, and thus, it is possible to apply LCDs to large-sized TVs, such as HD (High-Definition) TVs. Thereby, LCDs are receiving attention as novel displays able to substitute for CRTs, which used to be synonymous for displays.

In the LCDs, because the liquid crystals themselves cannot emit light, an additional light source is provided at the back surface thereof so that the intensity of light passing through the liquid crystals in each pixel is controlled to realize contrast. More specifically, the LCD, serving as a device for adjusting light transmittance using the electrical properties of liquid crystal material, emits light from a light source lamp mounted to the back surface thereof, and the light thus emitted is passed through various functional prism films or sheets to thus cause light to be uniform and directional, after which such controlled light is also passed through a color filter, thereby realizing red, green, and blue (R, G, B) colors. Furthermore, the LCD is of an indirect light emission type, which realizes an image by controlling the contrast of each pixel through an electrical method. As such, a light-emitting device provided with a light source is regarded as important in determining the quality of the image of the LCD, including luminance and uniformity.

Such a light-emitting device is mainly exemplified by a backlight unit. Typically, a backlight unit causes light to be emitted using a light source such as a cold cathode fluorescent lamp (CCFL), so that such emitted light is sequentially passed through a light guide plate, or a light diffusion member, including a light diffusion plate or a light diffusion sheet, and a prism sheet, thus reaching a liquid crystal panel. The light guide plate or the diffusion plate functions to transfer light emitted from the light source in order to distribute it over the entire front surface of the liquid crystal panel, which is planar, and the light diffusion member, such as the light diffusion plate or light diffusion sheet, performs a hiding function so that a device mounted under the light diffusion member, such as the light source, is not seen from the front surface while uniform light intensity is realized over the entire surface of a screen. The prism sheet functions to control the light path so that light traveling in various directions through the light diffusion member is transformed within a range of viewing angle θ suitable for viewing an image by an observer. Further, a reflection sheet is provided under the light guide plate or the diffusion plate to reflect light, which does not reach the liquid crystal panel and is outside of the light path, so that such light is used again, thereby increasing the efficiency of use of the light source.

Recently, in order to further simplify the manufacturing process, attempts to decrease the use of optical films have been made. Such attempts have included cases in which a prism sheet was adhered onto a light diffusion plate and in which a prism pattern was formed on a light diffusion plate. In these cases, although cost or productivity was improved, luminance was not increased as desired.

Typically, with the intention of refracting light diffused through the light diffusion member in a front surface direction while passing through the prism sheet, it is preferred that an air layer be present between the light diffusion member and the prism sheet. When the prism sheet is simply disposed on the light diffusion member, an air layer is formed, even though it is very thin. In the course of assembling a backlight unit, however, in the case where the light diffusion member and the prism sheet are adhered using an adhesive or the prism pattern is formed on the light diffusion plate to increase workability, an air layer is not formed, by which luminance is decreased.

Further, in the course of assembling a backlight unit, scratches may occur, and some limitations are imposed on hiding properties because the light source must transmit light even though it is hidden. Furthermore, in the course of lamination of the sheets, it is impossible to completely eliminate the fear of causing stains by light interference. If the adhesion process is conducted using the adhesive as above, stains may be formed due to the adhesive.

### DISCLOSURE

### Technical Problem

Accordingly, the present invention provides an optical composite, in which a light diffusion member and an optical sheet are integrated through adhesion and an air layer is included, thus increasing working efficiency and preventing luminance from being decreased.

In addition, the present invention provides an optical composite, in which adhesion portions between a light diffusion member and an optical sheet are regularly arranged to induce an optical illusion effect so that scratches or stains cannot be seen clearly.

In addition, the present invention provides an optical composite, which exhibits excellent hiding properties while uniformly diffusing light emitted from a light source.

Also, the present invention provides a method of manufacturing an optical composite, which is capable of stably forming an air layer to sufficiently increase luminance and obviates the additional use of optical films or prism sheets for increasing luminance.

In addition, the present invention provides a method of manufacturing an optical composite, which does not decrease luminance even in the presence of an adhesion portion.

### Technical Solution

According to the present invention, there is provided an optical composite, comprising a structural layer, having a light transfer surface and a plurality of three-dimensional (3D) structures having a uniform height; an adhesion portion formed on one surface of the structural layer; and a light-collecting layer formed on one surface of the adhesion portion.

In the optical composite, an air passage may be formed between the 3D structures of the structural layer.

In the optical composite, the light transfer surface of the structural layer may not be flat.

The optical composite may further comprise either or both of a bottom layer formed on a surface of the structural layer opposite the light transfer surface and a surface layer formed on the light transfer surface of the structural layer.

In the optical composite, either or both of the surface layer and the bottom layer may contain light-diffusing particles.

In the optical composite, the light-diffusing particles may be contained in an amount of 0.01˜30 parts by weight, based on 100 parts by weight of a resin constituting either or both of the surface layer and the bottom layer.

In the optical composite, the adhesion portion may have total light transmittance of 90% or more.

In the optical composite, the adhesion portion may have a refractive index of 1.40˜1.60.

In the optical composite, the adhesion portion may have an adhesive force of 100˜1000 g/25 mm.

In the optical composite, the adhesion portion may be formed of a UV curing agent or a heat curing agent, and may have a viscosity of 100˜15000 cps after curing.

In the optical composite, the adhesion portion may be formed of a solid adhesive.

In the optical composite, the adhesion portion may have a thickness of 10 μm or less.

In the optical composite, the 3D structures of the structural layer may be a linear or non-linear arrangement of structures having a shape selected from among a polygonal conical shape, a conical shape, a hemispherical shape, and an aspherical shape.

In the optical composite, the structural layer may have a constant distance between peak points of two 3D structures adjacent to each other.

In the optical composite, the 3D structures may have a pitch of 300 μm or less.

In the optical composite, the pitch of the 3D structures may be at least four times a height thereof.

In the optical composite, the adhesion portion may have a width of 1/10˜⅕ of the pitch of the 3D structures.

In the optical composite, the structural layer may be formed by co-extruding a base resin while passing through a pattern roller in contact therewith.

In the optical composite, the base resin may be selected from among a mixture of polycarbonate resin and polystyrene resin mixed at a weight ratio of 1:9˜9:1, polycarbonate resin, polystyrene resin, and methylmethacrylate resin.

In the optical composite, light-diffusing particles may be further contained in an amount of 10˜500 parts by weight based on 100 parts by weight of the base resin.

In the optical composite, the light-diffusing particles may be one or more selected from the group consisting of acrylic particles, including homopolymers or copolymers of methylmethacrylate, acrylic acid, methacrylic acid, hydroxyethyl methacrylate, hydroxypropyl methacrylate, acryl amide, methylol acryl amide, glycidyl methacrylate, ethyl acrylate, isobutyl acrylate, n-butyl acrylate, and 2-ethylhexyl acrylate; olefin particles, including polyethylene, polystyrene, and polypropylene; acryl-olefin copolymer particles; multilayer multicomponent particles, prepared by forming homopolymer particles, which are then coated with another type of monomer; siloxane-based polymer particles; tetrafluoroethylene particles; silicon oxide, aluminum oxide, titanium oxide, zirconium oxide, and magnesium fluoride.

In addition, according to the present invention, there is provided a method of manufacturing an optical composite, comprising preparing a structural layer, having a light transfer surface and a plurality of 3D structures having a uniform height; forming an adhesion portion on the flat surface of a light-collecting layer; and adhering the adhesion portion to the structural layer.

In addition, according to the present invention, there is provided a method of manufacturing an optical composite, comprising preparing a structural layer, having a light transfer surface and a plurality of 3D structures having a uniform height; applying an adhesive on the peaks of the 3D structures of the structural layer using a coating roll which is maintained at a uniform height from the structural layer; curing the applied adhesive, thus forming an adhesion portion; and laminating a light-collecting layer.

In the above method, the light transfer surface of the structural layer may not be flat.

In the above method, preparing the structural layer may comprise co-extruding a base resin while passing through a pattern roller in contact therewith.

In the above method, the adhesion portion may have an adhesive force of 100˜1000 g/25 mm.

In the above method, the adhesion portion may be formed of a UV curing agent or a heat curing agent, and has a viscosity of 100˜15000 cps after curing.

In the above method, the adhesion portion may be formed of a solid adhesive.

In the above method, the adhesion portion may have a width of 1/10˜⅕ of a pitch of the 3D structures of the structural layer.

In the above method, the adhesion portion may have a thickness of 10 μm or less.

### Advantageous Effects

According to the present invention, an optical composite can be provided, in which a light diffusion member and an optical sheet are integrated with each other through adhesion, thereby increasing working efficiency, and an air layer is included, thus preventing luminance from being decreased.

In addition, an optical composite can be provided, in which adhesion portions between a light diffusion member and an optical sheet are regularly arranged to thus induce an optical illusion effect so that scratches or stains cannot be seen clearly.

In addition, an optical composite for exhibiting excellent hiding properties while uniformly diffusing light emitted from a light source can be provided.

Also, an optical composite having sufficiently increased luminance due to the stable formation of an air layer and a method of manufacturing the same can be provided, and thus, there is no need to additionally use optical films or prism sheets for increasing luminance, thereby decreasing manufacturing costs, simplifying the manufacturing process, and realizing thinner displays.

Moreover, according to the present invention, in a method of manufacturing an optical composite, luminance is not decreased even in the presence of the adhesion portion, and an optical illusion effect is induced, so that scratches or stains cannot be seen clearly.

### DESCRIPTION OF DRAWINGS

FIG. 1 is a longitudinal cross-sectional view illustrating the optical composite according to the present invention;

FIGS. 2 to 12 are longitudinal cross-sectional views illustrating the modifications of the optical composite according to the present invention; and

FIG. 13 is a schematic view illustrating the process of forming adhesion portions on the optical composite according to the present invention.

* Description of the Reference Numerals in the Drawings *

100: structural layer
111: 3D structure
112: light transfer surface
120: adhesion portion
130: light-collecting layer
151: air passage
170: bottom layer
175: light-diffusing particles
180: surface layer
185: light-diffusing particles
400: roller

### BEST MODE

Hereinafter, a detailed description will be given of the present invention in conjunction with the appended drawings.

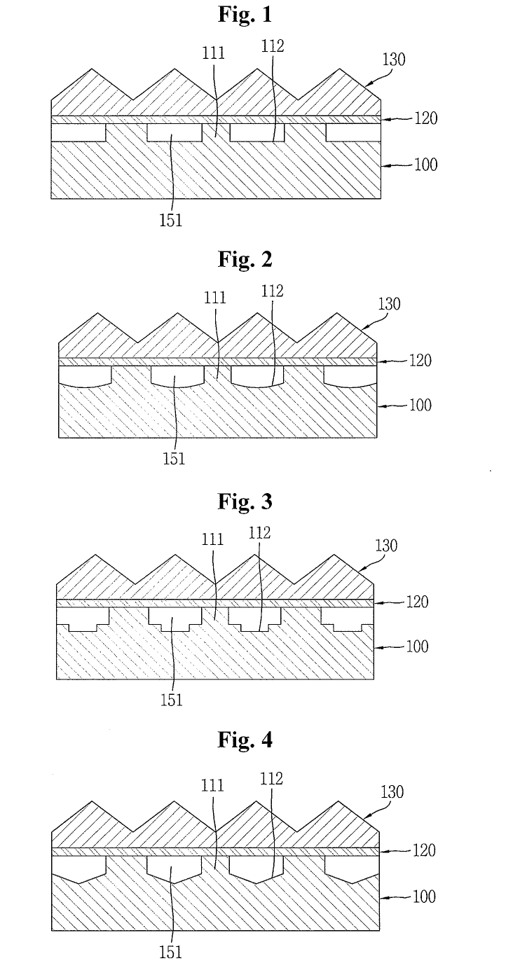

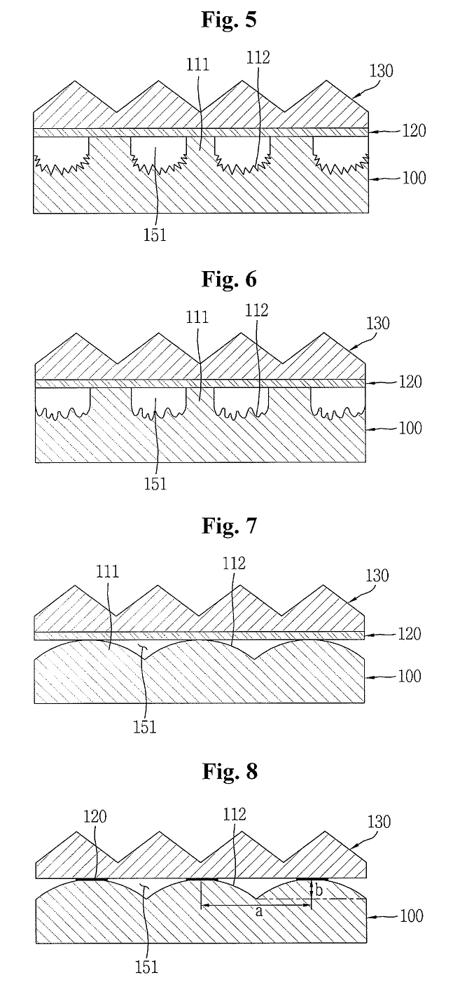

FIG. 1 is a longitudinal cross-sectional view illustrating the optical composite according to the present invention, and FIGS. 2 to 12 are longitudinal cross-sectional views illustrating the modifications of the optical composite according to the present invention. Throughout these drawings, the same elements are represented by the same reference numerals for convenience, but this does not indicate that the compositions and shapes thereof are the same as each other.

According to the present invention, an optical composite comprises a structural layer 100, an adhesion portion 120, and a light-collecting layer 130, which are sequentially formed.

The structural layer 100 includes a plurality of 3D structures 111 having a uniform height. The 3D structures 111 are adhered to the adhesion portion 120, whereby an air passage 151 is formed between the 3D structure 111 and the 3D structure 111, thus realizing an air-permeable structure.

Conventionally, a light diffusion plate is manufactured in such a manner that surface roughness is formed using light-diffusing particles to increase luminance. However, in consideration of compatibility of a base resin for a light diffusion plate, there are limitations in the size of the particles. When a light-collecting layer is formed on the light diffusion plate, an air passage 151 is not formed even with the use of light-diffusing particles that are as large as possible.

In the present invention, the structural layer 100 having the 3D structures 111 is included, thereby stably forming the air passage 151. Thus, while light that is sufficiently diffused in the structural layer 100 of the optical composite is passed through the air passage 151 composed of air to thus have a relatively low density and is then transferred to the light-collecting layer 130, which has a relatively high density, light is effectively transmitted toward the front surface by light circulation and light refraction, corresponding to the inherent functions of the light-collecting layer 130, ultimately increasing luminance.

As well as the structural layer 100 for diffusing light and the light-collecting layer 130 for gathering light, the air passage 151 is formed, thereby effectively increasing luminance. The functions of the diffusion film and the prism sheet, which are conventionally separately provided, are imparted to a single optical composite, so that the number of films to be mounted in a backlight unit is decreased, and luminance is the same as or is increased to be higher than the case where the light diffusion plate and the prism sheet are separately provided.

The 3D structures 111 are formed at a height that enables the permeation of air through the air passage 151.

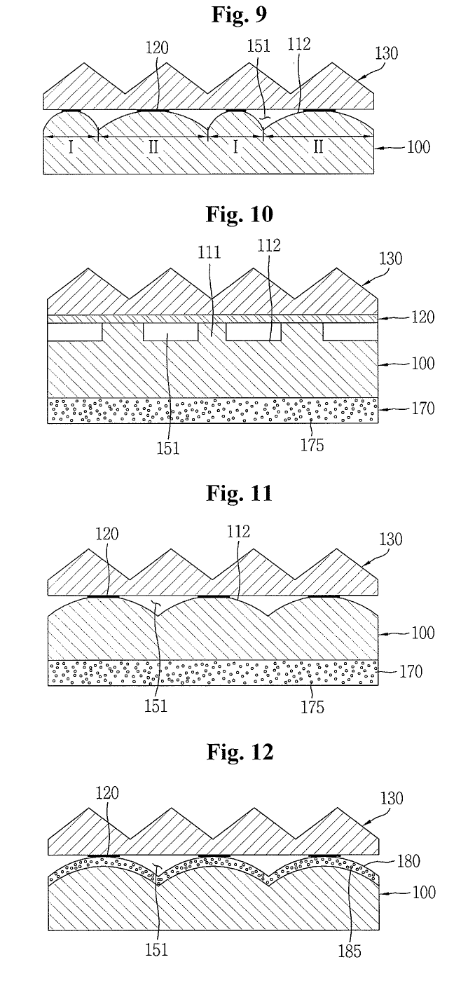

In particular, it is preferred that the 3D structures 111 of the structural layer 100 have a uniform height at peak points thereof, and that the distance a between the peak points of two 3D structures adjacent to each other be constant. If the distance between the peak points of two 3D structures is constant, all pitches may be formed at the same length, or the pitches between two patterns adjacent to each other may be formed to be different, as shown in FIG. 9. That is, even if the pitches I, II of two patterns adjacent to each other are different, the 3D structures may be regularly arranged in a repeating pattern so that the distance between the peak points of the two 3D structures is constant. When the prism sheet formed on the light diffusion member of the present invention is seen from the front surface, in the case where the light diffusion member and the prism sheet are adhered using an adhesive, stains, such as white spots, are visible on the adhered surface. When the distance between the peak points of the two 3D structures is constant, adhesion portions formed on the peaks are regularly arranged, so that stains, such as white spots, are wholly regularly visible, thereby causing a kind of optical illusion by which stains cannot be seen clearly. Conversely, in the case where the patterns are irregularly formed, such stains may be more clearly seen.

As mentioned above, that the distance a between the peak points of two 3D structures is constant is intended to regularly form white spots occurring at the time of laminating the prism sheet. In the pitches of the 3D structures 111 of the structural layer 100, even when two 3D structures 111 or three or more 3D structures 111, adjacent to each other, have different lengths, it will be apparent that they still fall within the technical scope of the present invention, under conditions in which the distance between the peak points of two 3D structures 111 is constant.

In the structural layer 100, the pitch of the 3D structures 111 may be at least four times the height b of the peak point thereof, and the pitch may be 300 μm or less. This is because the optical composite, which is positioned on the light source or the light guide plate, plays a role in supporting the other sheets that are laminated thereon, and thus the height is realized as low as possible, thus realizing a stable surface.

In the present invention, the structural layer 100 is not particularly limited to any shape, as long as it satisfies the above conditions, and may have a linear arrangement or non-linear arrangement of structures having any shape selected from among a polygonal conical shape, a conical shape, a hemispherical shape, and an aspherical shape.

Further, the structural layer 100 diffuses light through the light transfer surface 112, and may have various patterns to thus increase the diffusion efficiency of light. That is, as illustrated in FIG. 1, the light transfer surface 112 may be flat, and, as illustrated in FIGS. 2 to 9, the light transfer surface 112 may be variously patterned. The process of forming such 3D structures 111 is not particularly limited, and includes laser cutting, co-extrusion, roll transfer, hot pressing, screen printing, and lithography.

For example, the structural layer 100 may be prepared through co-extrusion. That is, a molten base resin is co-extruded while passing through a pattern roller in contact therewith, thus forming the structural layer. The extrusion temperature varies depending on the type of base resin, and is typically set to 200˜300° C. In this case, each structural layer 100 may be simply prepared using one type of resin. Examples of the base resin include a mixture of polycarbonate resin and polystyrene resin mixed at a weight ratio of 1:9˜9:1, polycarbonate resin, polystyrene resin, methylmethacrylate, or styrene-acryl copolymer resin.

In addition to the above preparation process, the structural layer 100 may be formed by applying a polymer resin containing a UV curable resin or a heat curable resin on one surface of a substrate film.

The substrate film includes a polyethylene terephthalate film, a polycarbonate film, a polypropylene film, a polyethylene film, a polystyrene film, or a polyepoxy film. Particularly useful is a polyethylene terephthalate film or a polycarbonate film.

The polymer resin containing a UV curable resin or a heat curable resin includes a resin composition which is very transparent and is able to form a crosslink bond necessary for maintaining the shape of an optical structure. Examples thereof include epoxy resin-Lewis acid or polyethylol, unsaturated polyester-styrene, acrylic acid or methacrylic acid ester. Particularly useful is acrylic acid or methacrylic acid ester resin, which is very transparent. Such a resin is exemplified by oligomers, such as polyurethane acrylate or methacrylate, epoxy acrylate or methacrylate, and polyester acrylate or methacrylate, and may be used alone or in mixtures with an acrylate or methacrylate monomer having a polyfunctional or monofunctional group.

The thickness of the substrate film is set to make it suitable for mechanical strength, thermal stability, and flexibility, and the substrate film is preferably 10˜1000 μm thick to prevent the loss of transmitted light, and more preferably 15˜400 μm thick.

In the substrate film, the light-diffusing particles may be dispersed in a single layer form or a multilayer form, have a particle size of 1˜100 μm, and may be contained in an amount of 10˜500 parts by weight based on 100 parts by weight of the base resin. In the case where the light-diffusing particles having the above particle size are used in the above amount, appropriate light diffusion effects may be realized while preventing the generation of white turbidity and the separation of the particles.

The light-diffusing particles include pluralities of organic or inorganic particles. Typical examples of the organic particles include acrylic particles, including homopolymers or copolymers of methylmethacrylate, acrylic acid, methacrylic acid, hydroxyethyl methacrylate, hydroxypropyl methacrylate, acryl amide, methylol acryl amide, glycidyl methacrylate, ethyl acrylate, isobutyl acrylate, n-butyl acrylate, and 2-ethylhexyl acrylate; olefin particles, including polyethylene, polystyrene, and polypropylene; acryl-olefin copolymer particles; multilayer multicomponent particles, prepared by forming homopolymer particles, which are then coated with another type of monomer; siloxane-based polymer particles; and tetrafluoroethylene particles, and examples of the inorganic particles include silicon oxide, aluminum oxide, titanium oxide, zirconium oxide, and magnesium fluoride. The above organic and inorganic particles are merely illustrative, are not limited to the examples listed above, and may be replaced with other known materials as long as the main purpose of the present invention is achieved, as will be apparent to those skilled in that art. The case in which the type of material is changed also falls within the technical scope of the present invention.

In addition, in the optical composite of the present invention, as shown in FIGS. 10 and 11, a bottom layer 170 may be further formed beneath the flat surface of the structural layer 100, and may contain light-diffusing particles 175.

The bottom layer 170 may be formed through a known process, co-extrusion molding, lamination, thermal adhesion, surface coating, etc. In the case where the bottom layer is formed through the extrusion of a molten base resin, the extrusion temperature may vary depending on the type of base resin, but is preferably set to 200˜300° C. The base resin may be selected from among a mixture of polycarbonate resin and polystyrene resin mixed at a weight ratio of 1:9˜9:1, polycarbonate resin, and polystyrene resin.

In the case where the bottom layer 170 is formed through curing, the binder resin is composed of a resin that adheres well to the structural layer 100 and has good compatibility with light-diffusing particles 175 to be dispersed therein, for example, a resin in which the light-diffusing particles 175 are uniformly dispersed so that they are not separated or precipitated. Specific examples thereof include acrylic resin, including homopolymers, copolymers, or terpolymers of unsaturated polyester, methyl methacrylate, ethyl methacrylate, isobutyl methacrylate, n-butyl methacrylate, n-butylmethyl methacrylate, acrylic acid, methacrylic acid, hydroxyethyl methacrylate, hydroxypropyl methacrylate, hydroxyethyl acrylate, acrylamide, methylolacrylamide, glycidyl methacrylate, ethyl acrylate, isobutyl acrylate, n-butyl acrylate, and 2-ethylhexyl acrylate, urethane resin, epoxy resin, and melamine resin.

The light-diffusing particles 175 contained in the bottom layer 170 include organic particles or inorganic particles, and may be the same as or different from the light-diffusing particles contained in the structural layer 100. The light-diffusing particles 175 have a refractive index different from that of the base resin or the binder resin, are used to increase the diffusion efficiency of light, and function to impart hiding properties, transmittance and diffusivity at appropriate levels.

In the bottom layer 170, the light-diffusing particles 175 are contained in an amount of 0.01˜30 parts by weight based on 100 parts by weight of the base resin or the binder resin, in consideration of front-surface luminance while realizing damage prevention and light diffusion and preventing a decrease in the efficiency of use of light. In the case where the difference in refractive index between the light-diffusing agent and the base resin is large, the light-diffusing agent may exhibit light diffusion effects even when used in a small amount. Conversely, in the case where the difference in refractive index therebetween is small, the light-diffusing agent should be used in a relatively large amount. Further, when the amount of light-diffusing particles 175 is too large, luminance may be rather decreased. Thus, the amount of light-diffusing particles 175 is adjusted, so that high luminance is exhibited along with appropriate hiding properties.

The surface protrusions, formed by the dispersed light-diffusing particles 175, function to decrease the contact area with the facing surface in the process apparatus or another optical film which is laminated, during the loading or storage of optical films or the assembly of optical films with other parts, thereby preventing separation into respective layers and surface damage during transport and assembly. Such a bottom layer 170 has a predetermined thickness, which is not particularly limited, and is preferably 10˜200 μm thick.

As shown in FIG. 12, in the optical composite of the present invention, the structural layer 100 may further include a surface layer 180 on the structural surface thereof, and the surface layer 180 may contain particles 185.

The surface layer 180 may be formed in the same manner as the formation of the bottom layer 170, and the particles 185 may include organic particles or inorganic particles, as the light-diffusing particles as mentioned above, and may be the same as or different from the light-diffusing particles of the structural layer 100. In the surface layer 180, the particles 185 may be contained in an amount of 0.01˜30 parts by weight, based on 100 parts by weight of the base resin or the binder resin, in consideration of front-surface luminance while realizing light diffusion and hiding properties and preventing the efficiency of use of light from being decreased.

The thickness of the surface layer 180 is not particularly limited, and is set to 10μ200 μm.

In this way, the optical composite of the present invention may be provided with neither the bottom layer 170 nor the surface layer 180, may be selectively provided with either the low surface layer 170 or the surface layer 180, or may be provided with both the low surface layer 170 and the surface layer 180.

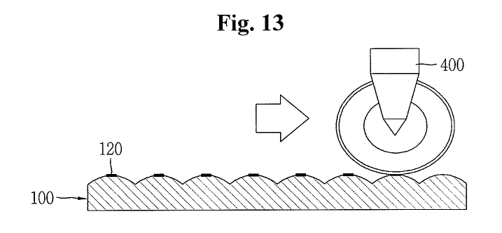

The adhesion portion 120 may be formed on the structural layer 100. In the case where the adhesion portion is formed by applying a liquid adhesive on the structural layer 100, the adhesive is applied only on the peaks, so that the entire 3D structures of the structural layer 100 are not covered therewith even though the adhesion portion 120 is compressed by the light-collecting layer 130 which is to be laminated thereon, thus ensuring the air passage 151, thereby preventing the luminance from being decreased. The process of forming the adhesion portion 120 is not particularly limited, but is conducted in a manner such that an adhesive material is slightly applied only on the peaks of the 3D structures of the structural layer 100 using a roller 400, as shown in FIG. 13, in order to prevent the adhesive material from infiltrating into the space between the 3D structures, and is then subjected to UV curing or rapid heat curing to cure it before flowing down, in order to maintain a viscosity of 100˜15000 cps after curing. The adhesion portion has an adhesive force of 100˜1000 g/25 mm such that the structural layer 100 and the light-collecting layer 130 are firmly adhered to each other. The width of the adhesion portion 120 may be 1/10˜⅕ of the pitches of the 3D structures 111 of the structural layer 100.

The adhesion portion 120 should be transparent so as not to decrease luminance, and should have total light transmittance of 90% or more and a refractive index of 1.40˜1.60. To this end, the adhesion portion 120 is composed of a curable adhesive material, including a UV curing agent or a heat curing agent, and specifically, one or more selected from among acrylic resin, silicone resin, epoxy resin, and urethane resin.

In addition to the roller coating of the structural layer 100 with the liquid adhesive material as above, the process of forming the adhesion portion 120 includes applying the curable adhesive material and then curing it, or using a solid adhesive such as an adhesive film or a piece of double-sided tape. When the formation of the adhesion portion 120 beneath the light-collecting layer 130 and then the attachment thereof to the structural layer 100 are carried out, the adhesive material does not flow down along the surface of the 3D structures 111 of the structural layer 100, thus facilitating the stable formation of the air passage 151. In order to stably fix the structural layer 100 and the light-collecting layer 200, the adhesive force of the adhesion portion 120 may be set within the range from 100˜1000 g/25 mm.

In order to exhibit adhesive performance and minimize the negative effect on optical performance, the adhesion portion 120 may have a thickness of 5˜50 μm.

In this way, the light-collecting layer 130 is laminated on the structural layer 100, after which the air passage 151 is formed between the 3D structures 111 to thus cause a difference in refractive index from the light-collecting layer 130, resulting in increased luminance.

The composition of resin used for the light-collecting layer 130 is not particularly limited, and includes known resins for use in conventional prism sheets or prism films. For example, a UV polymerizable monomer or oligomer mixture and a photoinitiator may be included.

The light-collecting structures of the light-collecting layer 130 may have a polyhedral shape, the cross-section of which is polygonal, semicircular, or semi-elliptical, or a column shape, the cross-section of which is polygonal, semicircular, or semi-elliptical. A combination of one or more shapes may be applied. Such structures may be respectively arranged to be adjacent to each other or not. The light-collecting layer 130 functions to control the light path so as to transmit diffused light toward the front surface, thereby further increasing luminance.

The optical composite of the present invention may further added with a process stabilizer, a UV absorber, or a UV stabilizer, as needed.

While the invention has been disclosed as above with reference to the drawings, which are set forth to illustrate, but are not to be construed to limit the invention, it will be understood by those skilled in the art that various changes can be made thereto without departing from the technical spirit of the invention.

### [Mode for Invention]

A better understanding of the present invention may be obtained through the following examples, which are set forth to illustrate, but are not to be construed as the limit of the present invention.

### Example 1

One surface of a structural layer (TT: 70%, haze: 99%) formed of polymethylmethacrylate and having a thickness of 2.0 mm was patterned through a process such as laser cutting so that 3D structures were spaced apart from each other at intervals of 100 μm to thus form an air passage in a shape having a height of 50 μm at the deepest portion and a width of 100 μm, as illustrated in FIG. 2, thus completing the structural layer.

A piece of double-sided tape (manufacturing company: Sumiron, model name: TG4191, total light transmittance: 99%, refractive index: 1.49, thickness: 25 μm) was attached to the lower surface of a prism sheet (refractive index: 1.59, substrate film: polyethyleneterephthalate (PET), thickness: 188 μm, pitch: 50 μm, height: 25 μm) as a light-collecting layer, thus forming an adhesion portion, which was then adhered to the upper surface of the 3D structures of the structural layer, thereby manufacturing an optical composite.

### Example 2

Example 1 was modified such that one surface of a structural layer (TT: 70%, haze: 99%) formed of polymethylmethacrylate and having a thickness of 2.0 mm was subjected to roll transfer to thus form an air passage in a shape having a height of 50 μm at the deepest portion and a width of 100 μm, as illustrated in FIG. 3, thus completing the structural layer.

### Example 3

Example 1 was modified such that a structural layer was imprinted in a pattern shape as illustrated in FIG. 4 using a press. As such, the 3D structures had a width of 100 μm and a height of 50 μm at the deepest portion, and the width of the air passage was 100 μm.

### Example 4

Example 1 was modified such that a prism sheet (refractive index: 1.55, substrate film: PET, thickness: 188 μm, pitch: 50 μm, height: 25 μm) was used.

### Example 5

Example 1 was modified such that a structural layer formed of a polycarbonate resin was used.

### Example 6

Example 1 was modified such that a piece of double-sided tape having total light transmittance of 85% was used.

### Example 7

Example 1 was modified such that, on the other surface of a structural layer (TT: 70%, haze: 99%) formed of polymethylmethacrylate resin and having a thickness of 1.8 mm, a bottom layer composed of 100 parts by weight of polymethylmethacrylate resin and 1 part by weight of silicon beads and having a thickness of 0.2 mm was formed through co-extrusion. Thereafter, an air passage, an adhesion portion, and a light-collecting layer were formed in the same manner as in Example 1, thus completing an optical composite.

### Example 8

Polycarbonate resin pellets and polystyrene resin pellets were mixed at a weight ratio of 1:1, melted at 250° C., extruded to a thickness of 2.0 mm, and then passed through a pattern roller in contact therewith so that convex lens patterns having a semi-elliptical shape having a pitch of 250 μm and a height of 50 μm in longitudinal cross-section were regularly arranged on one surface of a structural layer, thereby preparing the structural layer.

Thereafter, using a roller device (manufacturing company: DaeYoung Laminator, model name: JW096), an adhesive (manufacturing company: Sam Won, model name: MO-40) was applied on the peaks of the structural layer through roller coating, as illustrated in FIG. 13, and was then heat-cured, thus forming adhesion portions having a width of 30 μm and a height of 10 μm. Thereafter, peel strength was measured to thus indicate adhesive force. The adhesive force was determined to be 1000 g/25 mm, and the viscosity was determined to be 1500 cps. Specifically, the peel strength was measured in a manner such that a heat-cured adhesion portion 13 mm wide was attached to a given workpiece (stainless plate-SUS303), and was then compressed through three reciprocal movements of a roller having a weight of 2 kg at a rate of 300 mm/min, after which the adhesion portion was peeled at a rate of 300±30 mm/min while being folded on itself by an angle of 180°, and the strength when the peeled length of the adhesion portion reached 25 mm was measured using a tensile force tester (Shimaozy Autograph AGS-100A).

On the 3D structures coated with the adhesion portions, a prism sheet (refractive index: 1.59, substrate film: PET, thickness: 188 μm, pitch: 50 μm, height: 25 μm) was laminated, thus realizing a lamination structure with the structural layer, thereby manufacturing an optical composite.

### Example 9

An optical composite was manufactured in the same manner as in Example 8, with the exception that the 3D structures of the structural layer were formed such that convex lens patterns having a pitch of 200 μm and convex lens patterns having a pitch of 300 μm were alternately arranged in a repeating pattern.

### Example 10

An optical composite was manufactured in the same manner as in Example 8, with the exception that a bottom layer as illustrated in FIG. 11 was formed beneath the structural layer. The bottom layer was formed on the flat surface of the structural layer, by co-extruding a mixture comprising 100 parts by weight of a base resin, composed of polycarbonate resin pellets and polystyrene resin pellets mixed at a weight ratio of 1:1 and then melted at 250° C., and 1 part by weight of silicon beads, and had a thickness of 0.2 mm.

### Example 11

An optical composite was manufactured in the same manner as in Example 8, with the exception that a surface layer as illustrated in FIG. 12 was formed on the structural layer. The surface layer was formed on the structural surface of the structural layer by co-extruding a mixture comprising 100 parts by weight of a base resin, composed of polycarbonate resin pellets and polystyrene resin pellets mixed at a weight ratio of 1:1 and then melted at 250° C., and 1 part by weight of silicon beads, and had a thickness of 0.2 mm.

### Example 12

An acrylate oligomer resin (refractive index: 1.57) was applied on a mold with which the same structural layer as in Example 8 could be formed, after which a PET film (HeeSung Electronics, LM170E01) was laminated thereon, cured using UV light at an intensity of 120 watts for 3 sec, and then separated from the metal mold, thus preparing a structural layer. Thereafter, adhesion portions were formed in the same manner, and a prism sheet was adhered thereto, thus manufacturing an optical composite.

### Example 13

An optical composite was manufactured in the same manner as in Example 10, with the exception that the adhesion portion was formed using an adhesive film (manufacturing company: Sumiron, model name: TG4193, total light transmittance: 99%, refractive index: 1.49, thickness: 10 μm) having a thickness of 10 μm and an adhesive force of 1000 g/25 mm, instead of the adhesive.

### Comparative Example 1

Example 1 was modified such that an air passage was not formed, and a prism sheet was adhered using a piece of double-sided tape.

### Comparative Example 2

Example 1 was modified such that a piece of double-sided tape was attached to the structural surface of the structural layer, and then a prism sheet was attached thereto.

### Comparative Example 3

An adhesive used in Example 8 was applied through roll coating on one surface of a light diffusion member (manufacturing company: Kolon, trade name: DP350, thickness: 2.0 mm, transmittance: 70.0%, haze: 99%) having no 3D structure, and was then cured, after which the flat surface of a prism sheet (manufacturing company: Kolon, trade name: LC213, thickness: 188 μm, pitch: 50 μm, height: 25 μm, inclination: 45°) was adhered thereto, thus manufacturing an optical composite.

### Comparative Example 4

An optical composite was manufactured in the same manner as in Example 10, with the exception that the height and pitch of the peak points of the 3D structures of the structural layer were randomly determined in the range of 100˜300 μm.

The optical composites manufactured in the above examples and comparative examples were evaluated for luminance, hiding properties, and stains as follows. The results are given in Table 1 below.

(1) Luminance

The optical composite of each of the above examples and comparative examples was mounted to a backlight unit for 17″ LCD panels, and the luminance values of 13 random points were measured using a luminance meter (model name: BM-7, Topcon, Japan), averaged, and then evaluated according to the following:

⊚: luminance of 4500 cd/m² or more

◯: luminance between 3500 cd/m² and less than 4500 cd/m²

Δ: luminance between 3000 cd/m² and less than 3500 cd/m²

×: luminance less than 3000 cd/m²

(2) Hiding Properties

The optical composite of each of the above examples and comparative examples was mounted to a backlight unit for 42″ LCD panels, and whether the light source was visible was observed with the naked eye, and the degree of visibility was relatively evaluated as below.

Degree of visibility: weak←⊚-◯-Δ-×→strong

(3) Evaluation of Stains

The optical composite of each of the above examples and comparative examples was mounted to a backlight unit for 42″ LCD panels, and whether stains, such as white spots, were visible was observed with the naked eye, and the degree of visibility was relatively evaluated as below.

Degree of visibility: weak←⊚-◯-Δ-×→strong

TABLE 1

| | Luminance | Hiding | Stains |
|---|---|---|---|
| Ex. 1 | ◯ | ◯ | ◯ |
| Ex. 2 | ◯ | ◯ | ◯ |
| Ex. 3 | ◯ | ◯ | ◯ |
| Ex. 4 | Δ | ◯ | ◯ |
| Ex. 5 | ◯ | ◯ | ◯ |
| Ex. 6 | Δ | ◯ | ◯ |
| Ex. 7 | ◯ | Δ | Δ |
| Ex. 8 | ⊚ | Δ | ◯ |
| Ex. 9 | ◯ | Δ | ◯ |
| Ex. 10 | ⊚ | ⊚ | ⊚ |
| Ex. 11 | ◯ | ◯ | ◯ |
| Ex. 12 | ◯ | Δ | ◯ |
| Ex. 13 | ⊚ | ⊚ | ◯ |
| C. Ex. 1 | X | Δ | ◯ |
| C. Ex. 2 | Δ | Δ | Δ |
| C. Ex. 3 | X | Δ | ◯ |
| C. Ex. 4 | Δ | ◯ | X |

As is apparent from the above results, the optical composites manufactured in the examples of the present invention had luminance at an appropriate level or higher, through which stains could not be seen well, and furthermore, hiding properties and luminance were maintained at a good level. Thereby, luminance was observed to be more greatly affected by the total area ratio of the air layer than by the pattern shape or formation method of the air passage or 3D structures. When the total light transmittance of the adhesion portion was decreased, the loss of light occurred, slightly decreasing luminance.

Conversely, in the comparative examples, stains were observed without hindrance, thus adversely affecting an image even though luminance and hiding properties were maintained at a good level. Not only in the case where the air passage was not formed but also in the case where the ratio of the air layer was decreased due to the adhesion portion by the sequence of formation of the adhesion portion, luminance could be seen to be decreased.

1. An optical composite, comprising:
a structural layer, having a light transfer surface and a plurality of three-dimensional structures having a uniform height;
an adhesion portion formed on one surface of the structural layer; and
a light-collecting layer formed on one surface of the adhesion portion.

2. The optical composite according to claim 1, wherein an air passage is formed between the three-dimensional structures of the structural layer.

3. The optical composite according to claim 1, wherein the light transfer surface of the structural layer is not flat.

4. The optical composite according to claim 1, further comprising either or both of a bottom layer formed on a surface of the structural layer opposite the light transfer surface and a surface layer formed on the light transfer surface of the structural layer.

5. The optical composite according to claim 4, wherein either or both of the surface layer and the bottom layer contain light-diffusing particles.

6. The optical composite according to claim 5, wherein the light-diffusing particles are contained in an amount of 0.01-30 parts by weight, based on 100 parts by weight of a resin constituting either or both of the surface layer and the bottom layer.

7. The optical composite according to claim 1, wherein the adhesion portion has total light transmittance of 90% or more.

8. The optical composite according to claim 1, wherein the adhesion portion has a refractive index of 1.40-1.60.

9. The optical composite according to claim 1, wherein the adhesion portion has an adhesive force of 100-1000 g/25 mm.

10. The optical composite according to claim 1, wherein the adhesion portion is formed of a UV curing agent or a heat curing agent, and has a viscosity of 100-15,000 cps after curing.

11. The optical composite according to claim 1, wherein the adhesion portion is formed of a solid adhesive.

12. The optical composite according to claim 1, wherein the adhesion portion has a thickness of 10 μm or less.

13. The optical composite according to claim 1, wherein the three-dimensional structures of the structural layer are a linear or non-linear arrangement of structures having a shape selected from among a polygonal conical shape, a conical shape, a hemispherical shape, and an aspherical shape.

14. The optical composite according to claim 1, wherein the structural layer has a constant distance between peak points of two three-dimensional structures adjacent to each other.

15. The optical composite according to claim 1, wherein the three-dimensional structures have a pitch of 300 μm or less.

16. The optical composite according to claim 1, wherein a pitch of the three-dimensional structures is at least four times a height thereof.

17. The optical composite according to claim 13, wherein the adhesion portion has a width of 1/10˜⅕ of the pitch of the three-dimensional structures.

18. The optical composite according to claim 1, wherein the structural layer is formed by co-extruding a base resin while passing through a pattern roller in contact therewith.

19. The optical composite according to claim 18, wherein the base resin is selected from among a mixture of polycarbonate resin and polystyrene resin mixed at a weight ratio of 1:9-9:1, polycarbonate resin, polystyrene resin, and methylmethacrylate resin.

20. The optical composite according to claim 18, wherein light-diffusing particles are further contained in an amount of 10-500 parts by weight based on 100 parts by weight of the base resin.

21. The optical composite according to claim 5, wherein the light-diffusing particles are one or more selected from a group consisting of acrylic particles, including homopolymers or copolymers of methylmethacrylate, acrylic acid, methacrylic acid, hydroxyethyl methacrylate, hydroxypropyl methacrylate, acryl amide, methylol acryl amide, glycidyl methacrylate, ethyl acrylate, isobutyl acrylate, n-butyl acrylate, and 2-ethylhexyl acrylate; olefin particles, including polyethylene, polystyrene, and polypropylene; acryl-olefin copolymer particles; multilayer multicomponent particles, prepared by forming homopolymer particles, which are then coated with another type of monomer; siloxane-based polymer particles; tetrafluoroethylene particles; silicon oxide, aluminum oxide, titanium oxide, zirconium oxide, and magnesium fluoride.

22. A method of manufacturing an optical composite, comprising:
preparing a structural layer, having a light transfer surface and a plurality of three-dimensional structures having a uniform height;
forming an adhesion portion on a flat surface of a light-collecting layer; and
adhering the adhesion portion to the structural layer.

23. A method of manufacturing an optical composite, comprising:
preparing a structural layer, having a light transfer surface and a plurality of three-dimensional structures having a uniform height;
applying an adhesive on peaks of the three-dimensional structures of the structural layer using a coating roll which is maintained at a predetermined height from the structural layer;
curing the applied adhesive, thus forming an adhesion portion; and
laminating a light-collecting layer.

24. The method according to claim 22, wherein the light transfer surface of the structural layer is not flat.

25. The method according to claim 22, wherein the preparing the structural layer comprises co-extruding a base resin while passing through a pattern roller in contact therewith.

26. The method according to claim 22, wherein the adhesion portion has an adhesive force of 100-1000 g/25 mm.

27. The method according to claim 22, wherein the adhesion portion is formed of a UV curing agent or a heat curing agent, and has a viscosity of 100-15,000 cps after curing.

28. The method according to claim 22, wherein the adhesion portion is formed of a solid adhesive.

29. The method according to claim 23, wherein the adhesion portion has a width of 1/10-⅕ of a pitch of the three-dimensional structures of the structural layer.

30. The method according to claim 22, wherein the adhesion portion has a thickness of 10 μm or less.

31. The optical composite according to claim 13, wherein the structural layer has a constant distance between peak points of two three-dimensional structures adjacent to each other.

32. The optical composite according to claim 13, wherein the three-dimensional structures have a pitch of 300 μm or less.

33. The optical composite according to claim 13, wherein a pitch of the three-dimensional structures is at least four times a height thereof.

34. The optical composite according to claim 20, wherein the light-diffusing particles are one or more selected from a group consisting of acrylic particles, including homopolymers or copolymers of methylmethacrylate, acrylic acid, methacrylic acid, hydroxyethyl methacrylate, hydroxypropyl methacrylate, acryl amide, methylol acryl amide, glycidyl methacrylate, ethyl acrylate, isobutyl acrylate, n-butyl acrylate, and 2-ethylhexyl acrylate; olefin particles, including polyethylene, polystyrene, and polypropylene; acryl-olefin copolymer particles; multilayer multicomponent particles, prepared by forming homopolymer particles, which are then coated with another type of monomer; siloxane-based polymer particles; tetrafluoroethylene particles; silicon oxide, aluminum oxide, titanium oxide, zirconium oxide, and magnesium fluoride.

35. The method according to claim 23, wherein the light transfer surface of the structural layer is not flat.

36. The method according to claim 23, wherein the preparing the structural layer comprises co-extruding a base resin while passing through a pattern roller in contact therewith.

37. The method according to claim 23, wherein the adhesion portion has an adhesive force of 100-1000 g/25 mm.

38. The method according to claim 23, wherein the adhesion portion is formed of a UV curing agent or a heat curing agent, and has a viscosity of 100-15000 cps after curing.

39. The method according to claim 23, wherein the adhesion portion has a thickness of 10 μm or less.
